(19) United States
(12) Patent Application Publication
(10) Pub. No.: US 2005/0084126 A1
(43) Pub. Date: Apr. 21, 2005

(54) Speaker housing without insulation capable of increasing sound output

(76) Inventor: Heard Milton, Baltimore, MD (US)

Correspondence Address: Johnson & Associates, PC, 14625 Baltimore Ave, Laurel, MD, 20724, US

(21) Appl. No.: 10/927,399

(22) Filed: Aug. 27, 2004

Related U.S. Application Data
(60) Provisional application No. 60/497,922, filed on Aug. 27, 2003.

(51) Int. Cl. H04R 25/00; H04R 1/02; H04R 1/20; H04R 9/06

(52) U.S. Cl. 381/336; 381/150; 381/337; 381/387; 381/160; 381/352; 381/345

(57) ABSTRACT

The present invention relates to a speaker housing having a triskaidecagon or a tridecagon geometric shape comprising eight rhombi and four isosceles triangles obtained by equaling separating two rhombi along their major axis and a single square panel for mounting a central speaker. This speaker housing is capable of the following functions: producing sound over a wide range of frequencies while minimizing unwanted audio waves distortions; allowing high and low frequencies efficiently with enhanced fidelity; minimizing interferences associated with the “back wave” phenomenon which has thus far plagued speaker housing designs existing in the prior art; and capable of trapping and using the back audio wave energy to help propagate sound from the large, yet compact surface area of the speaker housing assembly.

### RELATED PATENT APPLICATION

This application benefits from the earlier filing date of a U.S. provisional application Ser. No. 60/497,922, filed on Aug. 27, 2003.

### BACKGROUND OF THE INVENTION

1. Field of the Invention

The present invention relates to a resonant speaker housing without insulation but capable of increasing sound output by suppressing unwanted audio waves within the speaker housing.

2. Description of Related Prior Art

The preservation of the fidelity of an audio signal from the pickup to the output of an amplifier is of utmost importance when dealing with a speaker system comprising a speaker, a housing and a amplifier.

To achieve this elusive fidelity goal, the stereo industry have tried a number of strategy including optimization of the electromechanical component of the speaker device itself, which converts audio waves into corresponding sound waves. A section of the industry has researched with some success in design of the driver and success in improving the design of the speaker cone. Others have successfully made improvements in the speaker diaphram. However, success in improving the speaker housing or resident cavity to which the drivers are coupled have been elusive to date; to this end the present invention has been directed with extreme success.

The most expensive speakers with their associated speaker housing existing in the prior art have been found to add substantial amount of distortion to the audio signal output.

That is, prior and contemporary design in the speaker system have not led to the desired audio frequency response. The stereo industry has relentlessly attempted to reduce the gap in the frequency and the accuracy between a speaker housing and a corresponding amplifier have developed speakers of increasing quality and expense but have had limited success in closing the gap. Little or no attention have been placed on the speaker enclosure or housing, although there have been numerous attempt to design speaker housings with new geometric configuration to eliminate the gap between the speaker housing system and the corresponding amplifier.

Thus far all attempts to develop a speaker housing superior to traditional speaker housings, such as the conspicuous rectangular speaker box has not been successful in achieving the industry's goal, which is the conversion of audio voltage to density waves of audio frequency and amplitude in a manner that minimizes the distortion while maximizing the “.liveliness” characteristics of the reproduced sound.

The liveliness concept is a matter of psycho-acoustical quality which is subjective to various interpretations and/or individual taste and preferences. In contrast the conversion of audio voltage to density waves of audio frequency and amplitude in a manner that minimizes distortion is a physical characteristics.

Acoustical distortions occurs in many ways. A primary problem with the poor frequency response of the speaker housing has been that the sound which is heard from the speaker is produced by a combination of the speaker and its inefficient housing. This occurs because the speaker radiates sound from both the front and the rear of the speaker diaphram. When the speaker diaphram moves forward the air or atmosphere in front of the diaphram is compressed. Simultaneously, the forward motion of the cone causes movement of the air along the back surface of the diaphram. On the reverse or backward movement of the diaphram this action is reversed and the air in front of the diaphram is moved forward while the air behind the diaphram is simultaneously compressed.

The phenomenon described in the immediate paragraph above leads to a situation where the sound behind the speaker or the “front wave” as opposed to the sound behind the speaker or “backwave” is 180 degrees out of phase relative to the other. This is significant because the “backwave” reflects from the back panel or other surfaces of the prior art housing into the back surface of the speaker assembly and causes huge distortions by interfering with its mechanical movement. This type of distortions destroys cripness and generally deteriorates the quality of the sound reproduced. Conventional loudspeaker disclosed in the prior art have all attempted to overcome the well-known problems associated with the backside waves. But these prior art have all failed to overcome the phenonmenon of the back wave interference during the critical period of converting audio voltage to density wave of audio frequency and amplitude.

In Goldwater, U.S. Pat. No. 4,157,741, there is disclosed a speaker system with a phase plug for minimizing all yield distortion caused by phase differences between wave generated by the speaker diaphram by equalizing the wave path length between various portion of the diaphram and an exponential output horn of the speaker system. Foster, U.S. Pat. No. 2,646,852, disclosed a speaker housing which utilizes two balancing or equalizing chambers for discarding sound waves into a single conduit for final discharge outwardly from the speaker housing.

The prior art has also strived to dissipate the wave from the rear portion of the speaker. In Mitchell, U.S. Pat. No. 4,235,301, there is disclosed a speaker housing configured to channel sound wave emitted from a back surface of a driver speaker so that the sound waves are shifted in phase and emerged from a port of the speaker housing, so as to add the sound wave emitted from the front surface of the speaker. The prior art has also taught a rear back panel lying in a perpendicular plane to a center axis of the speaker assembly and provided with padding or various sound absorbing material attempting to dampen out and absorb the back wave.

In addition, some prior art have attempted to make the reflected wave from the back rear wall to be in phase with the front wave and thereby reinforcing the front wave by making the length from the speaker to the back rear wall a certain predetermined distance. However, the so-called reinforcing technique of the front wave have been proven to be impractical due to the wide range of frequencies.

In U.S. Pat. Nos. 4,142,604 by Smith and U.S. Pat. Nos. 4,280,586 by Petersen there are disclosed speaker housing having pyramidal configurations. U.S. Pat. Nos. 4,073,365 issued to Johnson there are disclosed speaker housings having hexahedronal and tetrahedronal configurations respectively.

U.S. Pat. No. 4,231,446 issued to Weiss et al discusses additional limitation of the conventional box speaker of the prior art. Because the prior art speaker housing radiates sound in a cone-like shape pattern from the front panel when two such housings are combined in spaced apart relationship the direction of the sound creates a hole between the two sources. The hole is created because when two or more wave front converges they form a resultant wave front of lesser curvature than one of them. A “presence” is lost and the listener knows very well that the sound is being beam at him from a small source. A “presence” is defined as the quality of self-assurance and effectiveness that permit a performer to achieve a rapport with the audience. Thus when the normal box-like speaker enclosure or housing is used the speaker placement and acoustic environment become critical factors and stereo image is hindred. The quality of presence lies in the shape of the external wave form reaching the ear of the listener.

To solve the limitations discussed Weiss et al disclosed a resonating chamber with a rhombic dodecahedron configuration. The configuration disclosed by Weiss has two or more opposed rhombi with special openings or with one of more corner thereof truncated and terminated with a baffle plate having a opening thereon for mounting a speaker unit. The rhombic dodecahedron geometric description taught by Weiss comprises twelve rhombi each rhombi having a pair of opposed 70 degrees corner angles and a pair of opposed 110 degrees corner angle. Each rhombus lies in the plane that forms 120 degrees with an adjacent rhombus or a dihedral angle. Each rhombus has a major axis that bisect the pair of opposed 70 degrees corner angle and a minor axis that bisect the pair of opposed 110 degrees corner angles. In a rhombic dodecahedron configuration the rhombus shape panel either meet to define a four-edge corner or a three-edge corner. A four-edge corner or a three-edge corner is truncated to provide a mount place for speaker units.

Although limited, weiss et al embodies and teaches similar objectives and advantages of the present invention. That is, a speaker housing which allows a speaker to perform over a wide frequency range with minimum distortions; a housing which allows for lower and high sound frequencies to be reproduced with a higher order of efficiency and fidelity; a speaker housing which allows for a substantial increase in the frequency range; a housing which minimizes the interference of the back wave.; an housing which seals in the back wave and utilizes its energy to propogate from the relatively large surface of the housing.; a housing which improves the quality of the sound by sealing in the back wave so that it is not emitted out of phase so as to cause interference with the front wave; a housing which improves the “presence” character of the sound by the omni-directional propagation of the broad wave front of low curvature; a housing in which speaker placement in acoustic environment with a widely separated stereo player seize to be critical factors; a speaker housing in which low medium and high frequency ranges of sound are reproduced with a high degree of fidelity so that less expensive unit can be incorporated therein without sacrificing the quality; a housing in which there is not distortions of the tones produced over a wide variety of frequency range; and a speaker housing in which it is unnecessary to achieve “zero resonance” in the design by means of massive construction and dampers, such as tar and others materials.

However, the following differences exits: Weiss et al disclosed a rhombic dodecahedraon the present invention discloses a triskaidecagon or tridecagon as its preferred structure; Although both Weiss et al and the present invention use rhombi to form the shape of their respective polyhedron, the rhombi of the Weiss et al has a pair of opposed 70 corner angles and a pair of opposed 110 degree corner angles and the rhombi of the present invention has a pair of opposed 40 degrees corner angles and a pair of opposed 140 degrees corner angles. Weiss shape is comprised of 12 rhombi and probably a square panel not of a predetermined size and the present invention is comprised of 8 rhombi, 4 isoceles triangles manufactured from two rhombi and a square surface panel of predetermined width.

Our experiments have revealed that the surface area to volume ratio of the rhombic triskaidecagon or tridecagon of the present invention is more appropriate than the rhombic dodecagon taught by Weiss et al. That is, the percularity of the shape of the present invention imparts a better acoustic advantage to an enclosed volume of air in the speaker housing than the rhombi dodecahedron structure taught by Weiss, which uses a truncated process to mount a speaker unit. The truncated process is complex and result into one or more elongated or shortened zone within the structure.

In contrast to the elongated or shorten zone formed in the structure of Weiss due to truncation, the opposing angles of the rhombi that formed the structure of this present invention are constant. Any change or variation has been found to destroy the enclosure structure of this invention. The method of making this invention is also streamlined and straightforward as compared with the methods taught in the prior art. For example, Weiss et al truncated process is complex and result into one or more elongated or shortened zone.

In short, the existing speaker housing of the prior art have all failed to adequately address the issue of “backwaves” audio distortions. Improvements to related components of the speaker system such as improvement in the speaker itself, improvement in channel design within the speaker housing, improvement in wave dissipation mechanism etc. have all fallen short of the intended objectives of minimizing unwanted audio waves distortions, improving efficiency by utilizing the energy of the backwave within the speaker housing and streamlining the manufacturing process of the speaker housing, etc.

### SUMMARY OF THE INVENTION

An object of this invention is to disclose a speaker housing having a triskaidecagon or a tridecagon geometric shape and comprising of eight rhombi, four isosceles triangles obtained by equaling separating two rhombi along their major axis and a single square panel for mounting a central speaker.

Another object of this invention is to disclose a speaker housing having a triskaidecagon or tridecagon geometric shape capable of assisting an entire speaker system assembly produce sound over a wide range of frequencies while minimizing unwanted audio waves distortions.

Still, another object of this invention is to disclose a speaker housing having a triskaidecagon or tridecagon geometric shape capable of allowing high and low frequency to be reproduced efficiently with enhanced fidelity, capable of minimizing interferences associated with the “back wave” phenomenon which has thus far plagued speaker housing designs existing in the prior art, and capable of trapping and using the back audio wave energy to help propagate sound from the large, yet compact surface area of the speaker housing of the present invention.

Yet still, another object of this invention is to disclose a speaker housing having a triskaidecagon or a tridecagon geometric shape capable of enhancing the “presence characteristics” of emitted sound by omni-directional propagation of broad frontal wave having low curvature and capable of functioning without insulation, for example, damping materials for purposes of achieving “zero resonance”.

Still further, another object of this invention is to disclose a speaker housing having a triskaidecagon or a tridecagon geometric shape and when used in conjunction with other speaker housings of the present invention is capable of being placed at a considerable distance from the stereo player in a predetermined, spaced-apart relationship without resulting in an “acoustic hole” caused by the directional radiation of sound due to the simultaneous use of more than one speaker housing assembly.

A final object of this invention is to disclose methods of manufacturing a speaker housing having a triskaidecagon or a tridecagon geometric shape, which are less complex, less expensive, streamlined and enabling to one ordinarily skilled in the art as compared with methods for manufacturing or constructing other speaker housings delineated in all of the existing prior art.

### BRIEF DESCRIPTION OF THE DRAWINGS

Other aspects of this invention will become apparent from the following detailed description when taken in conjunction with the accompanying drawings, in which:

FIG. 1 is a perspective view showing the resonant speaker housing of the present invention having a triskaidecagon or a tridecagon geometric shape with a speaker of predetermined size mounted on its flat-square panel.

FIG. 2 is a transparent perspective view illustrating the resonant speaker housing of the present invention having a mounted speaker of a predetermined size with a conical diaphram, an outer frame and a rear magnet, having a center axis, a transverse axis, and illustrating absorbed/deflected “back waves” during operation.

FIG. 3 is a cross-sectional view of FIG. 2 of the present invention.

FIG. 4a is an exemplary method step for manufacturing the resonant speaker housing of the present invention wherein a circular opening of a square panel based on a predetermined width of the outer frame of a selected speaker is formed.

FIG. 4b is an exemplary method step for manufacturing the resonant speaker housing of the present invention showing a rhombus panel constructed from a sheet of material corresponding to the width of the square panel, wherein a major angle along the major axis and a minor angle along the minor axis of 140° and 40° respectively are shown.

FIG. 4c is an exemplary method step for manufacturing the resonant speaker housing of the present invention showing the separation of a rhombus panel along the major axis and the major angle to form isosceles triangles corresponding to the width of the square panel in FIG. 4a and the rhombus in FIG. 4b.

FIG. 4d is an exemplary method step for manufacturing the resonant speaker housing of the present invention showing four isosceles triangles connected to the square panel of FIG. 1.

FIG. 4e is an exemplary method step for manufacturing the resonant speaker housing of the present invention, wherein the binding edges of the square panel, isosceles triangles and the rhombi are truncated at an angle of 60°.

FIG. 4f is a geometric illustration of two panels joined along their respective binding edges, truncated at an angle of 60°, to form a two panel unit with an outward angle of 60° measured from a 180° surface.

FIG. 4g is an exemplary method step for manufacturing the resonant speaker housing of the present invention, wherein two rhombi panels are joined along their binding edges to form a two panel unit with an internal/inward angle of 120° measured from a 180° surface as illustrated in FIG. 4f.

FIG. 4h is an exemplary method step for manufacturing the resonant speaker housing of the present invention wherein four rhombi panels are joined along their binding edges to form a four panel unit with internal/inward angles of 120° and external/outward angles of 60° measured from a 180° surface as illustrated in FIG. 4f.

FIG. 4i is an exemplary method step for manufacturing the resonant speaker housing of the present invention wherein two rhombi panels are joined along their binding edges to form a two panel unit with internal/inward angles of 120° and external/outward angles of 60° measured from a 180° surface as illustrated in FIG. 4f.

FIG. 4j is an exemplary method step for manufacturing the resonant speaker housing of the present invention wherein a two-panel rhombi unit illustrated in FIG. 4i is attached to a four-panel rhombi unit illustrated in FIG. 4h along the BE axis to form a six-panel rhombi unit as illustrated in FIG. 4n.

FIG. 4k is an exemplary method step for manufacturing the resonant speaker housing of the present invention wherein a single rhombus is manufactured using the manufacturing technique illustrated in FIG. 4b.

FIG. 4l is an exemplary method step for manufacturing the resonant speaker housing of the present invention wherein a single rhombus manufactured in FIG. 4k is attached to a square panel/isosceles triangle structure unit illustrated in FIG. 4d.

FIG. 4m is an exemplary method step for manufacturing the resonant speaker housing of the present invention wherein the structural unit illustrated in FIG. 4l is attached to a structural unit illustrated in FIG. 4h at designated points.

FIG. 4n is an exemplary method step for manufacturing the resonant speaker housing of the present invention wherein the structural unit illustrated in FIG. 4i is attached to the structural unit illustrated in FIG. 4m, and the structural unit illustrated in FIG. 4k is attached to the structural unit illustrated in FIG. 4i.

FIG. 5 is another perspective view showing the resonant speaker housing of the present invention having a triskaidecagon or a tridecagon geometric shape with a speaker of predetermined size mounted on its flat-square panel.

FIG. 6 is an exemplary method step for manufacturing the resonant speaker housing of the present invention, wherein the square panel with the isosceles triangles are simultaneously formed on a single sheet of material as a single unit.

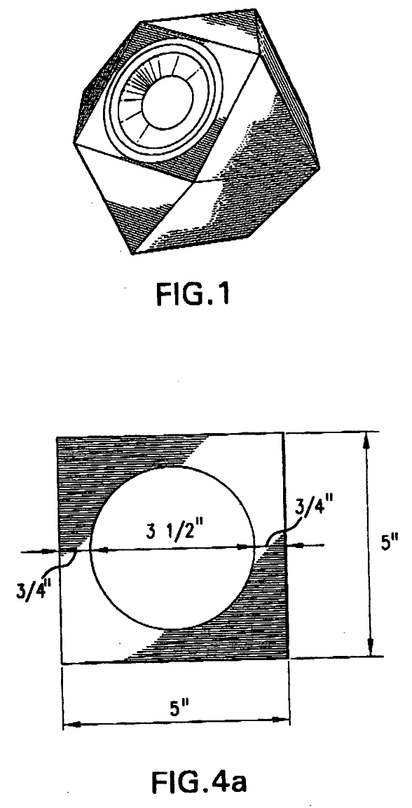

FIG. 1 is a perspective view showing the resonant speaker housing 10 of the present invention having a triskaidecagon or a tridecagon geometric shape with a speaker 35 of a predetermined size mounted on a flat square panel 25. The speaker housing 10 is comprised of 8 rhombus panels 300, four isosceles triangle panels 100 manufactured from the equal separation of two rhombus panels, and a square panel 25 of a predetermined width.

FIG. 2 is a transparent perspective view illustrating the resonant speaker housing 10 of the present invention wherein a speaker of a predetermined size a speaker 35 is mounted on a square panel 25 of the resonant speaker housing. The speaker 35 mounted on the flat panel 25 is a conventional speaker assembly 37 comprising a speaker frame 38, a conical diaphram 36, an outer frame 38 and a rear magnet 40. Still referring to FIG. 2, the speaker housing 10 contains a central axis 302, which runs directly through the front panel towards the back panel of the housing, and a transverse axis 301 which is perpendicular to the central axis 302 and runs laterally from one side of the speaker housing to the other side of the speaker housing.

The rhombic triskaidecagon or tridecagon geometric shape of the present invention either meets to define a four edge corner 56 or three edge corner 55.

The four edge corners 56 are located primarily in the front view, the side view and at least in one position in the rear view of the resonant speaker housing 10. Generally, the four edge corners 56 are formed by the joinder of a flat panel 25, with at least an isosceles triangle 100 and at least a rhombus panel 300. Specifically, the four edge corner 56 are formed by either two isosceles triangles 100, a flat panel 25 and a rhombus 100 converging at the major axes 29 of the isosceles triangles and the rhombus or by one isosceles triangle 100 and three rhombus panels 300 converging at the minor axes 28 of the isosceles triangle and the rhombus panels. In contrast to the four edge corners 56, the three edge corners 55 are formed by the joinder of three rhombus panels 300 converging along their major axis 29.

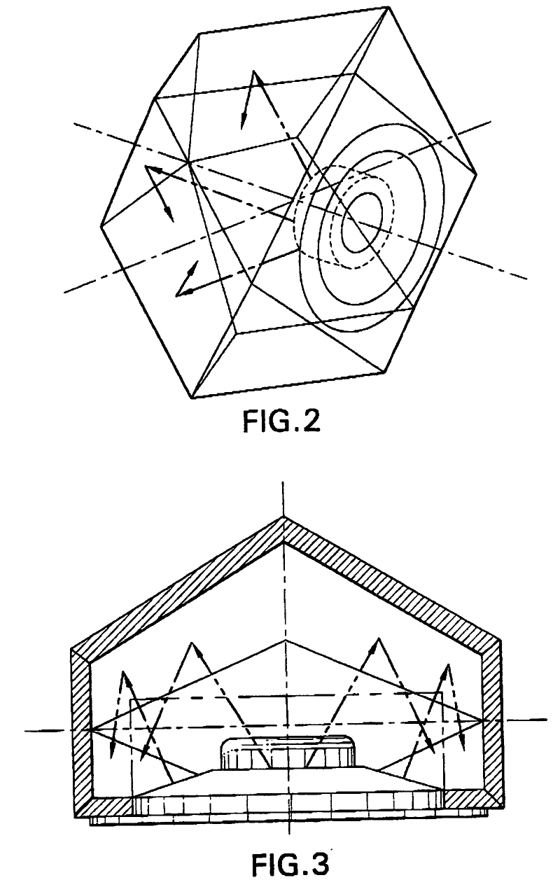

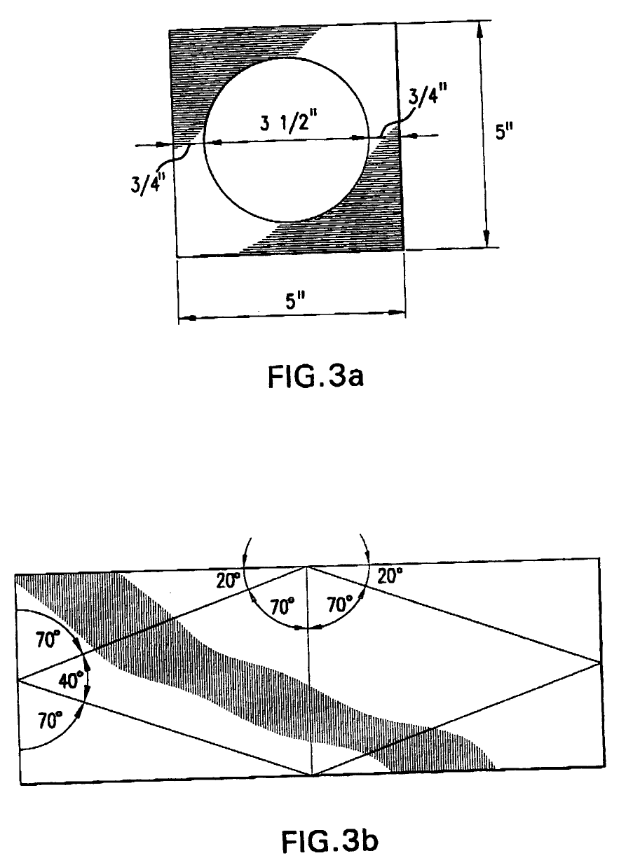

FIG. 3 is a cross sectional view of the transparent perspective view of FIG. 2, wherein the isosceles panels, the rhombus panels and a square panel that are used to form the speaker housing 10 are connected to form an internal/inward angle 18 of 120° and an external/outward angle 17 of 60° measured from a 180° surface plane.

Both FIGS. 2 and 3, illustrates “backwaves” 105 being propagated from the rear of the speaker assembly 35 when in operation which if not addressed results in acoustic distortions. In conventional speaker system, the speaker system radiates sound from both the front and the rear of the speaker cone. When the speaker cone moves forward the air or atmosphere in front of the cone is compressed and simultaneously the forward motion of the cone causes movement of the air along the back surface of the cone. On the reverse or backward movement of the cone this action is reversed and the air in front of the cone is moved forward while the air behind the cone is simultaneously compressed.

The sound in front of the speaker or the “front wave” as opposed to the sound behind the speaker or “backwave” 105 is at a 180 degrees out of phase relative to each other. Thus, the “backwave” is reflected from the back panel or other surface of the conventional speaker housing into the back surface of the speaker cone and causes distortions by interfering with its mechanical movement. Theses types of distortions destroys sound crippness and generally deteriotes the sound quality reproduced. Backwave interference also causes the speaker diaphram 36 to move back and forth thereby transmitting vibration through the speaker outer frame 38 to the speaker housing 10.

The “backwave” 105 propagated from the rear of the speaker system 35 are partially absorbed in the back panels of the housing and are deflected away and are deflected as deflected waves 106 away from the speaker assembly 35 (magnet 40, diaphram 36 and the speaker frame 38). This is primarily due to the unique geometric shape of the present invention, which has been proven to have a more adequate area to volume ratio, and imparts acoustic advantages to an enclosed volume of air as compared with the geometric speaker housing shape of the prior art.

Because the backwave energy to a large extent are utilize in this invention to cause vibration of the surface of the speaker housing, the choice of materials used in the construction of this invention includes light, unpadded resilent materials capable of functioning as a sounding board, such as aluminum, copper all hybrid metals, light plywood, plastic, glass, plastic-glass hybrid, and wood-glass hybrid, etc., which are in contrast with the heavy rigid materials and padding used in the prior art configuration.

Materials in Contrast With the Heavy Rigid Materials and Padding of the Prior Art.

In addition to partially absorbing and partially deflecting the backwave and utilizing the backwave energy to cause vibration of the speaker housing, the design and shape of the present invention also improves the “presence”, or the quality of self-assurance and effectiveness that permits a performer to achieve a rapport with the audience, by improving the shape of the external wave front reaching the ears of the listener. The external wave produced not only comes from the speaker assembly 35, but also from the relative large area of the tridecagon 10 vibrating in response to energy release by the backwave in a manner similar to a sounding-board without interfering with the speaker system. With increased “presence” a listener is made aware of sound being beam from a large source rather than a small source as taught in the related prior art disclosures.

This unique shape of the tridecagon housing allows two or more housing to be placed in space-apart relationship and yet overcomes the “acoustic hole” phenonmenon caused by directional radiation of sound due to the simulataneous use of more than one speaker housing assembly. This advantage may be explained by the fact that the speaker housing 10 absorbs a significant percentage of the backwaves 105, reflects a small portion of the backwave 105 away from the critical zone 19 as illustrated in FIG. 3, and produces omnidirectional sound radiation from a large surface area.

Spherical radiation of sound from the entire surface of the housing of the speaker housing eliminates the presence of an acoustic hole that has so plagued the prior art. The speaker housing 10 sound can be characterized emanating in substantially spherical shaped waves as opposed to the cone shaped waves of the prior art speaker housing. Thus speaker system placement in acoustic environment seizes to be critical factors, which is due to the inherent geometric shape (tridecagon) of the speaker housing rather than the mere design preference.

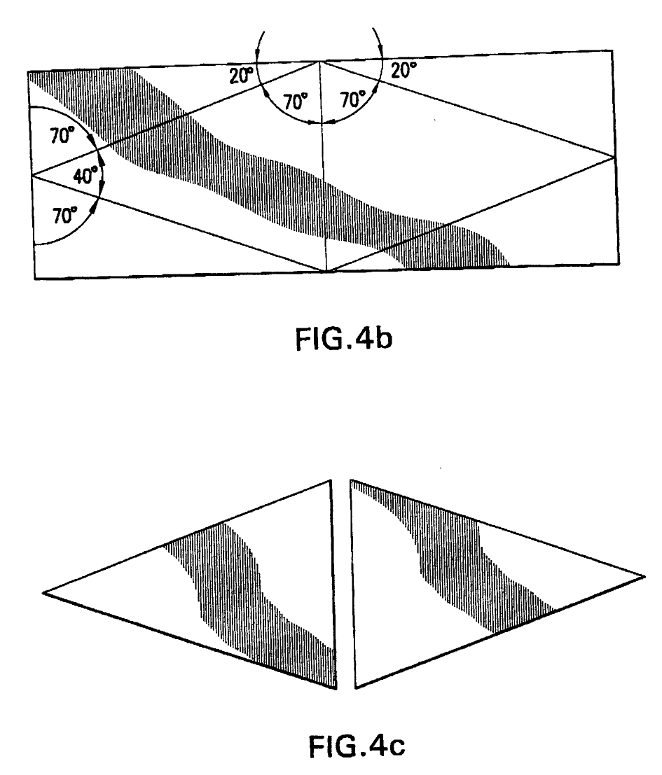

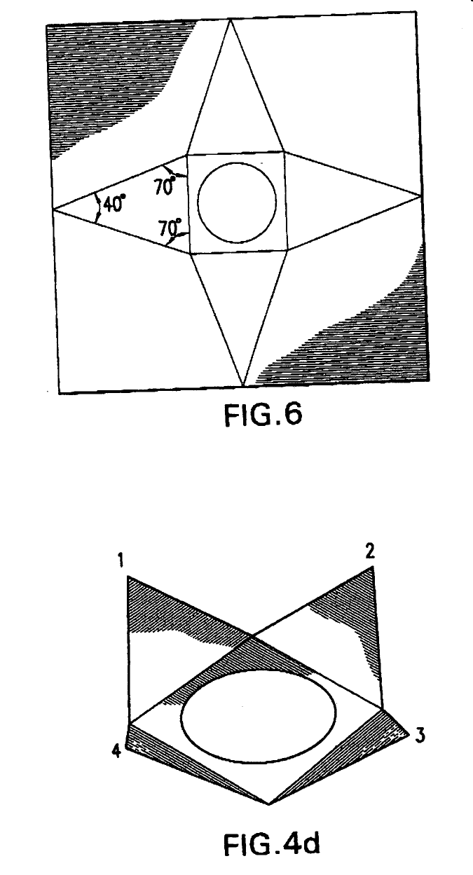

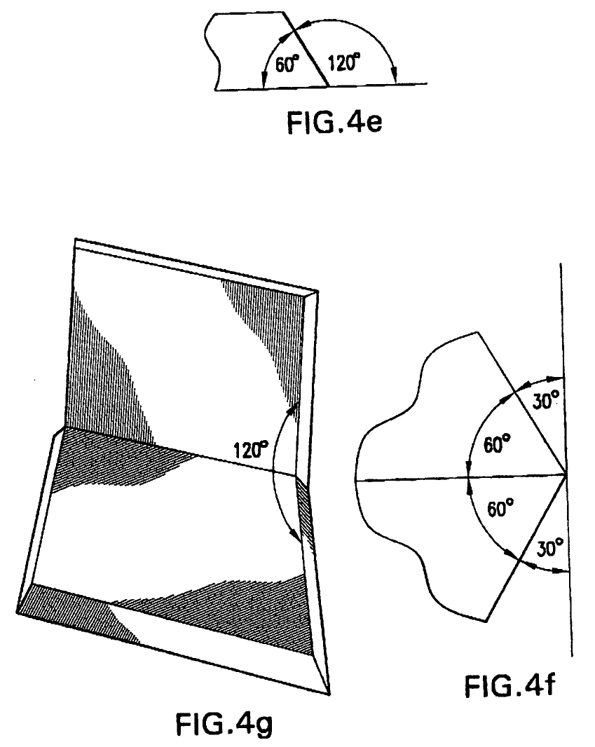

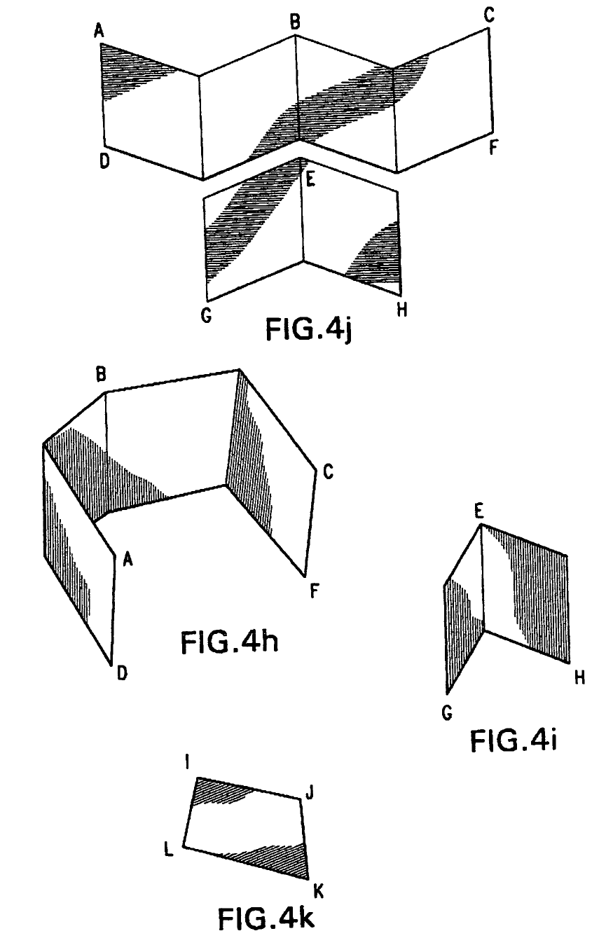

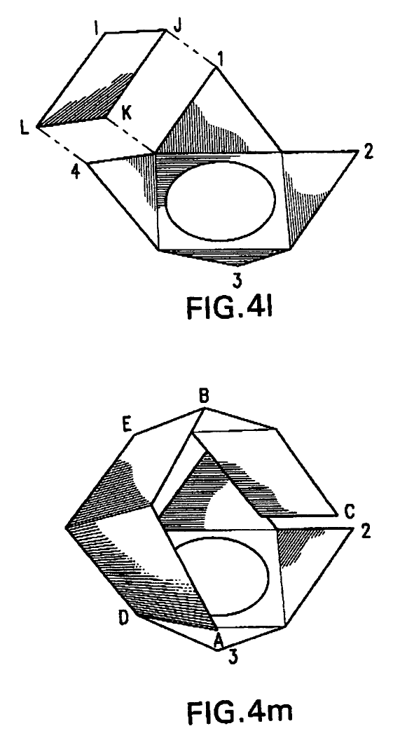

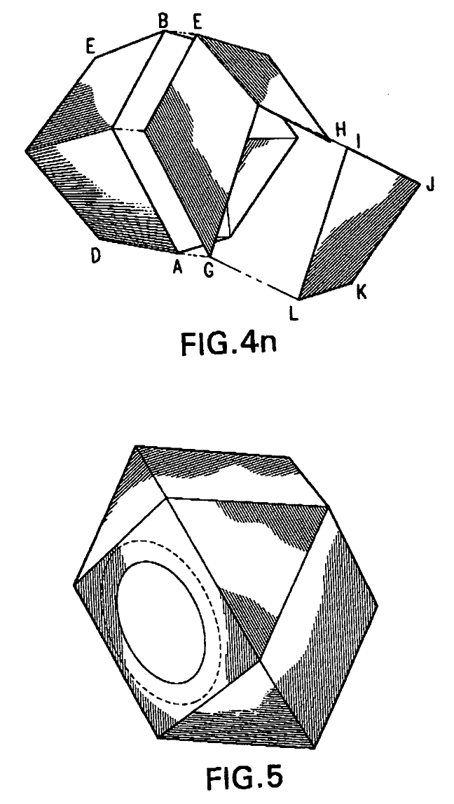

FIGS. 4a to 4n teaches a method of manufacturing the resonant housing 10 of the present invention. FIG. 4a is an exemplary method step for manufacturing the resonant speaker housing of the present invention wherein a circular opening 20 of a square panel 25 based on a predetermined width of the outer frame of the speaker is formed. In this example the outer frame of the speaker is 3½ inches a panel sheet of at least is required so that the circular opening of 3½ inches formed and two ¾ inches portions 13 is left for the external frame of the speaker to rest rest on such that the speaker fits on the front panel 25 because the magnet and diaphram portion fits within the circular portion 20 and the rest of the speaker rest on the panel 25. This example is done for a speaker with a total outer frame width of 5 inch and a diaphram conical portion including the magnet of a width of 3½ inch.

The speaker used have a maximum width of 5 inch and a diagphram/magnet portion of 3½ inch a five inch square panel sheet is used for designing such speaker illustrated in FIG. 4a.

Designing the square panel in FIG. 4a a rhombus panel is constructed from a sheet of material corresponding to the width of the square panel wherein a major angle along the major axis 29 and the minor angle along the minor axis 28 of 140 and 40 degrees respectfully are formed. The width of the major axis is based on the width of the square panel. In other words in this exemplary manufacturing step 4a the width of the panel was determined as 5 inches therefore the width of the length of the major axis 29 will be 5 inches. Then from the edges of the major axis. From corner of the major axis 152 a line 150 is projected from 20 degrees from the axis 152 to form two axis 160 and another line is projected from the other side at 152, 20 degrees from axis 158 to axis 160 to form ½ of the rhombus. Similar projections occurs at the opposite end to form the complete rhombus with 2 major angle along the major axis of 140 degrees and two minor angles along the minor of 40 degrees.

Lines 150 from the opposite end converges on the axis 160 to form the minor angle 40 degree along the minor axis 28 thereby forming a complete rhombus with boundary lines 150 with a major axis 29 and a minor axis 28 with a major angle 140 degrees and a minor angle of 40 degrees respectively.

This method is used for materials non-metal materials such glass, plywood, wood, laminates, plastic-glass hybrid, plastic wood hybrid, plastic laminate hybrid and all materials other than metal of all forms, such as aluminum, steel, bronze, all metal hybrids, etc.

Because materials other than metal are not malleable and ductile and is brittle to form the isosceles triangle the isosceles triangles have to be formed individually before mounting on the square panel to form the isosceles triangle/square panel structure described in figure ______.

FIG. 4c is an exemplary method step for manufacturing the resonant speaker housing showing the separation of a rhombus panel along the major axis 29 and the major angle 152 to form two isosceles triangles 100 corresponding to the width of the square panel in FIG. 4a and FIG. 4b. According to FIG. 4d, the isosceles triangles are then attached to the square panel 25 along junction 101 by the use of glue, arcrylic glue, stick glue, laminate glue or other form of adhesive well known in the art for attaching panels 100 to the square panel 25 of the present invention.

FIGS. 4e, 4f and 4g illustrates the truncation process of the edges of the rhombi panels, the isosceles triangles and the square panels prior to adhesive operations. Specifically, referring to FIG. 4e each panel be a rhombus panel, a square panel or an isosceles triangle panel are truncated along their respective edges 50 to form a 60 degrees angle.

FIG. 4f is a geometric illustration showing two rhombi panels 301 and 302 connected at junction 101 using an adhesive material in such a way to form an internal angle 18 of 120 degrees and external angle 17 of 60 degrees, this truncation step and adhesive step is similarly done using the square panel and the isosceles triangle all of these panels are truncated at a 60 degrees angle and are joined to one another such that the internal angle between the two panels are 120 degrees and the exterior angles are 60 degrees.

After the truncation and ahesive steps in FIGS. 4e-4g, four rhombi panels 301, 302, 303, 304 are connected using are truncated and connected using adhesive along line101 and are joined to form a four rhombi panel unit as illustrated in FIG. 4h. In FIG. 4i two rhombi panels 305 and 306 are truncated and connected at 101 using an appropriate adhesive.

Attachment means are welding, nails, glue of all type and brackets and braces.

1. An acoustical reproducing apparatus having a conventional speaker mounted therein and capable of increasing sound output while minimizing or eliminating audio distortions comprising a resonant speaker housing having a plurality of polygons.

2. The acoustical reproducing apparatus according to claim 1, wherein said polygon comprises at least a rhombus, a square panel and a triangle with binding edges truncated at a 60° angle.

3. The acoustical reproducing apparatus according to claim 2, wherein said rhombus and said triangle comprises a major axis and a minor axis.

4. The acoustical reproducing apparatus according to claim 3, wherein said major axis is 140° and said minor axis is 40°.

5. The acoustical reproducing apparatus according to claim 4, wherein said resonant speaker housing has a three edge corner and a four edge corner, and is capable of assisting a speaker system produce sound over a wide range of frequencies, capable of allowing high and low frequency to be reproduced efficiently with enhanced fidelity, capable of minimizing “back wave” interferences, capable of using the “back wave” energy to propagate sound from its surface area, capable of enhancing the “presence characteristics” of emitted sound by omni-directional propagation of broad frontal wave, capable of being used with similar speaker housings and a stereo player in a spaced-apart relationship and less expensive to manufacture.

6. The acoustical reproducing apparatus according to claim 5, wherein the manufacture of said resonant speaker housing comprises the steps of:
(a) forming said square panel having a circular opening corresponding to the width of a conventional speaker diaphram, wherein a horizontal distance and a vertical distance from edges of said square panel to tips of said circular opening is sufficient to contain the entire length of said speaker;
(b) forming rhombus panels with a major axis, a minor axis, a major angle and a minor angle, wherein said major axis equals the length and width of said square panel, and said major angle and said minor angle are 140° and 40° respectively;
(c) separating said rhombus panels to form isosceles triangles;
(d) truncating binding edges of said square panel, said rhombus panels and said isosceles triangles at a 60° angle;
(e) attaching four isosceles triangles to said square panel to form a four-isosceles, square panel unit.
(f) attaching four rhombi along their binding edges to form a four, rhombus-panel unit;
(g) attaching two rhombi along their binding edges to form a two-rhombus panel unit; and
(h) forming single, rhombus-panel units

7. The acoustical reproducing apparatus according to claim 6, wherein the manufacture of said resonant speaker housing further comprises the steps of:
(a) attaching a rhombus panel unit to said four-isosceles, one-square panel unit to form a rhombus, four-isosceles, square panel unit.
(b) attaching said rhombus, four-isosceles, square panel unit to said four-rhombus panel unit to form a five-rhombus, four-isosceles square panel unit.
(c) attaching said two-rhombus panel unit to said five-rhombus, four-isosceles square panel unit to form a seven-rhombus, four-isosceles, square panel unit.
(d) attaching a single, rhombus panel unit to said seven-rhombus, four-isosceles, square panel unit to form a eight-rhombus, four-isosceles, square panel unit.

8. The acoustical reproducing apparatus according to claim 7, wherein the manufacture of said resonant speaker housing further comprises the step of manufacturing a triskaidecagon.

9. The acoustical reproducing apparatus according to claim 8, wherein the manufacture of said resonant speaker housing further comprises the step of manufacturing a tridecagon.

10. The acoustical reproducing apparatus according to claim 9, wherein said rhombus panels, said isosceles panels and said square panels are attached with attachment means and said speaker housing lacks internal insulation.

11. An acoustical reproducing apparatus having a conventional speaker mounted therein and capable of increasing sound output while minimizing or eliminating audio distortions comprising a resonant speaker housing having a plurality of polygons.

12. The acoustical reproducing apparatus according to claim 11, wherein said polygon comprises at least a rhombus, a square panel and a triangle.

13. The acoustical reproducing apparatus according to claim 12, wherein said rhombus and said triangle comprises a major axis and a minor axis.

14. The acoustical reproducing apparatus according to claim 13, wherein said major axis is 140° and said minor axis is 40°.

15. The acoustical reproducing apparatus according to claim 14, wherein said resonant speaker housing has a three edge corner and a four edge corner, and is capable of assisting a speaker system produce sound over a wide range of frequencies, capable of allowing high and low frequency to be reproduced efficiently with enhanced fidelity, capable of minimizing “back wave” interferences, capable of using the “back wave” energy to propagate sound from its surface area, capable of enhancing the “presence characteristics” of emitted sound by omni-directional propagation of broad frontal wave, capable of being used with similar speaker housings and a stereo player in a spaced-apart relationship and less expensive to manufacture.

16. The acoustical reproducing apparatus according to claim 15, wherein the manufacture of said resonant speaker housing comprises the steps of:
(a) forming said square panel having a circular opening corresponding to the width of a conventional speaker diaphram, wherein a horizontal distance and a vertical distance from edges of said square panel to tips of said circular opening is sufficient to contain the entire length of said speaker;
(b) forming rhombus panels with a major axis, a minor axis, a major angle and a minor angle, wherein said major axis equals the length and width of said square panel, and said major angle and said minor angle are 140° and 40° respectively;
(c) forming a four-isosceles, square panel unit
(d) attaching four rhombi to form a four, rhombus-panel unit;
(e) attaching two rhombi to form a two-rhombus panel unit; and
(f) forming single, rhombus-panel units

17. The acoustical reproducing apparatus according to claim 16, wherein the manufacture of said resonant speaker housing further comprises the steps of:
(a) attaching a rhombus panel unit to said four-isosceles, square panel unit to form a rhombus, four-isosceles, square panel unit.
(b) attaching said rhombus, four-isosceles, square panel unit to said four-rhombus panel unit to form a five-rhombus, four-isosceles square panel unit.
(c) attaching said two-rhombus panel unit to said five-rhombus, four-isosceles square panel unit to form a seven-rhombus, four-isosceles, square panel unit.
(d) attaching a single, rhombus panel unit to said seven-rhombus, four-isosceles, square panel unit to form a eight-rhombus, four-isosceles, square panel unit.

18. The acoustical reproducing apparatus according to claim 17, wherein the manufacture of said resonant speaker housing further comprises the step of manufacturing a triskaidecagon speaker housing.

19. The acoustical reproducing apparatus according to claim 18, wherein the manufacture of said resonant speaker housing further comprises the step of manufacturing a tridecagon speaker housing.

20. The acoustical reproducing apparatus according to claim 19, wherein said rhombus panels, said isosceles panels and said square panels are attached with attachment means.
